(19) United States
(12) Patent Application Publication
(10) Pub. No.: US 2003/0128701 A1
(43) Pub. Date: Jul. 10, 2003

(54) Method of and apparatus for directing packet entities

(75) Inventor: Tuija Hurtta, Espoo (FI)

Correspondence Address: Ware, Fressola, Van Der Sluys & Adolphson, LLP, Building Five, Bradford Green, 755 Main Street, P.O. Box 224, Monroe, CT, 06468, US

(73) Assignee: Nokia Corporation

(21) Appl. No.: 10/045,646

(22) Filed: Jan. 9, 2002

(51) Int. Cl. H04L 12/28

(52) U.S. Cl. 370/389; 370/412

(57) ABSTRACT

A method for directing a packet to a required bearer of a set of bearers. The method comprising the steps of:

(a) receiving the packet,

(b) checking if the packet is a fragmented packet and if it is,

(c) checking if the packet comprises information related to selection of the correct bearer and if it does,

forwarding the packet to the correct bearer

storing fragmentation related information contained in the packet

receiving second packet

forwarding said second packet to the correct bearer based on the fragmentation related information,

and if it does not,

storing fragmentation related information contained in the packet

storing said packet;

receiving another packet containing information related to the selection of the correct bearer

forwarding another packet and the stored packet(s) to the correct bearer.

### FIELD OF THE INVENTION

The present invention relates to a method of and apparatus for directing packet entities in a telecommunications system.

### BACKGROUND OF THE INVENTION

Telecommunications networks typically operate in accordance with a given standard or specification which sets out what the various elements of the network are permitted to do and how that should be achieved. For example, the standard or specification may define whether the user, or more precisely, user equipment or terminal is provided with circuit switched and/or packet switched service. The standard or specification may also define the communication protocols and/or parameters which shall be used for the connection. In other words, the standards and/or specifications define the “rules” on which the communication can be based. Examples of the different standards and/or specifications for wireless communication include, without limiting to these, specifications such as GSM (Global System for Mobile communications) or various GSM based systems (such as GPRS: General Packet Radio Service). AMPS (American Mobile Phone System), DAMPS (Digital AMPS), WCDMA (Wideband Code Division Multiple Access) or TD/CDMA in UMTS (Time Division/Code Division Multiple Access in Universal Mobile Telecommunications System), IMT 2000 and so on.

In a typical wireless cellular communication system a base station serves mobile stations or similar terminal apparatus (mobile station MS in the GSM, User Equipment UE in the UMTS) via a wireless interface. Each of the cells of the cellular system can be served by an appropriate transceiver apparatus. For example, in the WCDMA radio access network the cell is served by Node B, which is connected to and controlled by an element called as a radio network controller (RNC) node. In the GSM radio network the cell is served by a base station (BTS), which is connected to and controlled by a base station controller (BSC) node. The BSC/RNC element may be connected to and controlled by a mobile switching center (MSC), a serving GPRS support node (SGSN) or similar facility. The controllers of a network are typically interconnected and there may be one or more gateways, such as a Gateway MSC (GMSC) or a Gateway GPRS support node (GGSN), for connecting the cellular network to other networks, such as to circuit or packet switched telephone or data networks, such as the Internet or an intranet. The gateway node provides one or several access points for the network to another network, that is a connection point between the two networks.

As mentioned above, the telecommunications network may be capable of providing wireless packet switched services. Examples of such networks include the GPRS (General Packet Radio Service) network, EDGE (enhanced data rate for GSM evolution) Mobile Data Network or an appropriate third generation telecommunication system such as the CDMA (code division multiple access) or TDMA (time division multiple access) based 3^{rd} generation telecommunication systems that are sometimes referred to as Universal Mobile Telecommunication System (UMTS). All these relate to the transfer of data to and from mobile stations. For example, the GPRS standard is provided in conjunction with the GSM (Global System for Mobile communications) standard. The GSM standard is a circuit switched service and is originally designed for speech services. There are elements of the GSM standard and the GPRS standard which are in common. The GPRS networks are described in more detail e.g. in 3GPP Technical Specification 3G TS 23.060 version 3.2.0, “General Packet Radio Service (GPRS); Service description; Stage 2”, January 2000. This document is incorporated herein by reference. An adaptation of the GPRS standard is also being proposed for use with the third generation standard UMTS, which typically uses code division multiple access. The packet data part of the UMTS is contained in the above referenced 23.060 specification, i.e. 23.060 applies for packet switched data both for the UMTS and the GPRS.

The data packets may be transferred via the network as a Packet Data Protocol (PDP) context. More particularly, PDP context refers to the part of the data connection that goes through the packet switched network (e.g. the GPRS/UMTS network). The PDP context can be seen as a logical connection from the wireless station to the access point of a gateway node, such as the GGSN, the access point being the connection point between the e.g. GPRS/UMTS mobile network and an external data network. The PDP context may also be referred to, instead of the term logical connection, as a logical association between the access point and the user.

It has been proposed to have secondary PDP contexts. The primary PDP context is the first PDP context established for a specific PDP (or IP) address. There may still be further PDP context for the same address and APN. They are called secondary PDP contexts. In the GPRS system proposed currently, a gateway node such as the GGSN has to classify downlink (that is in the direction from the base station to the user equipment) IP packets received with an IP address in order to carry those IP packets on the correct PDP context. However this proposal has the problem that the packet classification by the GGSN does not work if the packets are fragmented. This is because the GGSN uses transport header information TFT (Traffic Flow template) and PDP address to classify the packets. It should be appreciated that a mobile device or the like may have at most one PDP context without a TFT, whereas other PDP contexts with the same PDP address must have TFTs. The TFT includes information available in IP and transport layer headers, e.g. source address(es), source port(s) and destination port(s).

If the downlink IP packets are fragmented, the transport header will not be available in all resulting fragments. If the GGSN were then to classify IP packets based on transport header information (i.e. if any of the PDP contexts with the PDP address includes TFT with transport header information), the GGSN may send fragments not including the transport header on a wrong PDP context.

As an example, if the mobile station has a PDP context without a TFT, a PDP context with the source port 1234 in the TFT and a PDP context with the source port 5678 in the TFT, the GGSN sends fragments without the transport header on the first PDP context, whereas the fragment including the transport header is sent on the second or on the third PDP context depending on the source port of the transport header.

In the example above, if the mobile station does not have a PDP context without a TFT (i.e. the first PDP context). It will not receive fragments without the transport header at all.

### SUMMARY OF THE INVENTION

It is an aim of the embodiments of the present invention to address one or several of the above problems.

According to an aspect of the invention, there is provided a method for directing a packet to a required bearer of a set of bearers, the method comprising the steps of:

(a) receiving the packet;

(b) checking if the packet is a fragmented packet and if it is,

(c) checking if the packet comprises information related to selection of the correct bearer and if it does,

forwarding the packet to the correct bearer

storing fragmentation related information contained in the packet

receiving second packet

forwarding said second packet to the correct bearer based on the fragmentation related information.

and if it does not,

storing fragmentation related information contained in the packet storing said packet;

receiving another packet containing information related to the selection of the correct bearer

forwarding another packet and the stored packet(s) to the correct bearer.

### BRIEF DESCRIPTION OF DRAWINGS

For better understanding of the present invention, and in order to show how the invention may be implemented in practice, reference will now be made by way of example only to the accompanying drawings in which:

FIG. 1 shown a communication network in which the embodiments of the present invention may be used; and

FIG. 2 shows an packet divided into fragment packets;

### DESCRIPTION OF PREFERRED EMBODIMENTS OF THE INVENTION

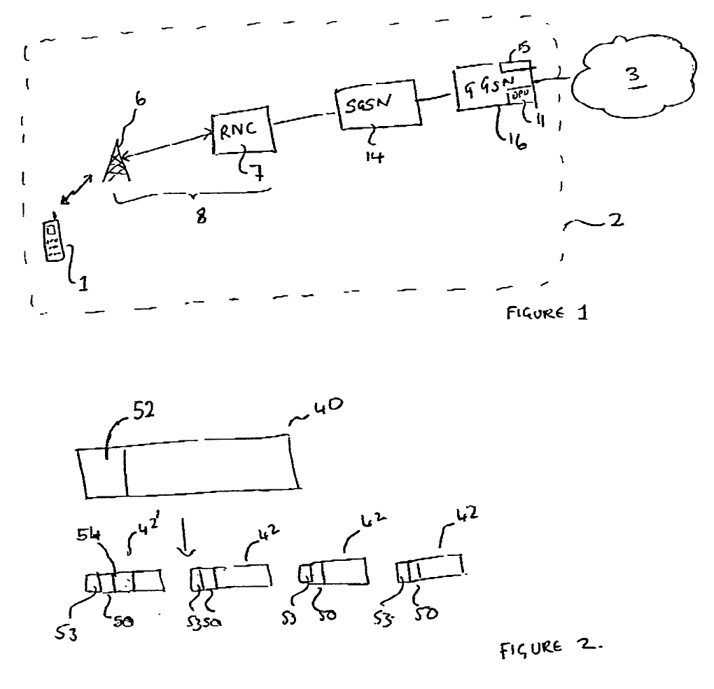

Reference is made to FIG. 1 which shows a communication system in which the embodiments of the present invention may be employed. The system is capable of providing wireless packet switched services for a user 1 thereof. The area covered by the communication system may be divided into a plurality of cells or similar access entities (not shown). Each cell has associated therewith a base station 6. Depending on the standard being used by the network, the base station is sometimes referred to as node B, for example in the third generation standards. The term base station will be used in this document to encompass all elements which transmit to wireless stations or the like via the air interface. A mobile station 1 i.e. the wireless user equipment is arranged to communicate with the respective base station. It should be appreciated that the term mobile station is intended to cover any suitable type of wireless user equipment, such as portable data processing devices and web browsers.

The embodiment of the invention is described in the context of a UMTS (Universal Mobile Telecommunications System) and a GPRS (General Packet radio Service) and communications involving packet data. However, it should be appreciated that embodiments of the present invention are applicable to any other communication system which deals with packet data.

The elements of a UMTS network system 2 will now be discussed in more detail. The mobile station or user equipment 1 is arranged to communicate via the air interface with a respective base station 6. The base station is controlled by a radio network controller RNC 7. The radio network controller RNC and the base station may sometimes be referred to as the radio network subsystem RNS 8 or radio access network RAN. It should be appreciated that a UMTS network is typically provided with more than one RNC, and that each radio network controller is arranged generally to control more than one base station 6 although only one base station is shown in FIG. 1. The elements of the RNS can be included in either or both of the RNC and the base station. This is an implementation issue.

The radio network subsystem 8 may be connected to a SGSN (serving GPRS support node) 14. The SGSN 14 keeps track of the mobile station's location and performs security functions and access control. The functions of the SGSN are defined in more detail e.g. in the 3GPP specification 23.060. The SGSN 14 is connected to a GGSN (gateway GPRS support node) 16. The GGSN 16 provides Interworking with an external packet switched network 3. In other words, the GGSN 16 acts as a gateway between the UMTS network 2 and the external data network 3, such as an IP based data network. The functions of a typical GGSN are also defined in the referenced 3GPP specification.

Although not shown, the network system 2 may also be connected to conventional telecommunication networks, such as to a GSM based cellular public land mobile network (PLMN) or to a public switched telephone network (PSTN). The various networks may be interconnected to each other via appropriate interfaces and/or gateways.

The following embodiment may be implemented in the GGSN 16 of FIG. 1, and more precisely, by means of a data processing unit 11 of the GGSN. However, it should be appreciated that the embodiment may also be applied in other network nodes of the network 2 as well, such as in the SGSN 14 and the RNC 7. The embodiments may also be applied in the mobile station 1.

Embodiments of the present invention address the problems of packet classification for fragmented IP packets by the GGSN or similar node.

Reference is made to FIG. 2 which shows an IP packet 40 which has been fragmented into a number of fragments 42. The original IP packet has an IP header 52. All the fragments have also an IP header 53 and may have additional IP level headers. The fragments 42 include information on the fragmentation. In case of IPv6 a Fragment Header 50 is added to the IP packets resulting from fragmentation. The Fragment Header 50 includes e.g. Identification information which is the same in all the fragments (which also have the same source address and destination address). In case of IPv4--[, this information is included in the IPv4 header. IPv6 Fragment Header is specified in RFC 2460 by IETF. IPv4 is specified in RFC 791 by IETF.

In the case of IPv6, only the sender is permitted to fragment an IPv6 packet. All the IPv6 packets resulting from the fragmentation include an IPv6 header including e.g. the source address and destination address of the IPv6 packet and possibly IP level headers which have to be processed hop by hop, that is IP level headers which have to be processed by additional nodes along the path, not just by the destination node. Additionally as mentioned above all of the fragments include a Fragment I leader with the following information; next header; fragment offset; M flag (M=1 means more fragments, M=0 means last fragment) and identification. The identification is the same in IPv6 fragments related to a source address—destination address pair. IPv6 packets with the same source address, destination address and identification in the Fragment Header should be carried on the same PDP context.

In the case of IPv4, other nodes along the path are also allowed to perform fragmentation. If fragmentation is performed, the IPv4 header includes information on the fragmentation, e.g. identification which is the same for all fragments related to a source address—destination address pair. IPv4 packets with the same source address, destination address and identification should be carried on the same PDP context.

Usually, the GGSN 16 receives the fragment 42′ including the information required for packet classification first. It is possible that only one of the fragments will include the information which is required for packet classification 54. This is the case e.g. if packet classification should be performed with transport layer information, e.g. with TCP or UDP port numbers. In this case, one of the TFT3 or packet classifiers related to the primary or secondary PDP contexts includes transport layer information. In IP networks, it is, however, possible that the GGSN receives other fragments first, and the fragment including the required information arrives later. If the GGSN has to classify packets with information which is not available in all the fragments, the GGSN should wait until it receives the fragment with the required information. When this fragment has been received, the GGSN knows on which PDP context all the fragments with the same destination address, source address and identification information should be sent towards the UF.

The GGSN stores information, preferably from the IPv6 header and from the Fragment Hheader or from the IPv4 header. In a store 15 on the fragmentation together with PDP context information. In particular the GGSN stores the source address and identification information and uses the stored information to classify fragments to the right PDP context. As a minimum the GGSN stores the identification information from the fragment header. It should be noted that the destination address or part of it is checked by the GGSN as the PDP address at packet classification. If the fragment 42 including the required information does not arrive first, the GGSN has to buffer fragments until it receives the fragment including this information.

In abnormal cases, e.g. when the GGSN buffers overflow, the GGSN may have to either send the old fragments on the most suitable PDP context (e.g. on the PDP context not including TFT if it exists or on a PDP context with lowest QoS) or drop old fragments to release buffer space for newer fragments.

In other embodiments of the invention, the GGSN may limit the time of waiting of the fragment which includes information required for packet classification. If the time limit expires without the required fragment being received, the GGSN may send the received fragments on the most suitable PDP context (e.g. on the PDP context not including TFT if it exists or on a PDP context with lowest QoS) which the GGSN selects without the required fragment.

It is also possible that the GGSN drops fragments if it can not decide on which PDP context the fragments should be sent. If one of the fragments is dropped, the GGSN may drop also all the other related fragments. If any of the fragments is missing, the UE can not form the original packet. In this case, dropping all fragments by the GGSN if any of the fragments is dropped may save radio resources, because then unnecessary fragments are not sent over the radio to the UE.

It should be appreciated that the GGSN may be dealing with a number of different fragments intended for the same or different destination at the same time.

The method embodying the present invention will now be described. In step S1 a packet fragment is received. In step S2, it is checked to see if the packet fragment contains the information required for packet classification. If so, the next step is step S3 where information from the fragment is stored in association with PDP context information. That packet fragment may in step S4 be sent on the required PDP context. If the fragment can not be sent on any PDP context, it is stored in the buffer.

If the packet fragment does not contain the information required for packet classification, a check is made in step S5 to see if the information has been previously received in a different packet fragment having the same source address, destination address and identification. If so the packet fragment is sent in step S6 on the required PDP context. If not the packet fragment is stored in the buffer in step S7. In step S3, a check is also made to see it there are any fragments in the buffer having the same source address, destination address and identification or the like which are waiting for the packet fragment with the information required for packet classification. If there are any such stored fragments, these are also sent on the required PDP context.

It should be appreciated that whilst embodiments of the present invention have been described in the context of packet fragments, embodiments of the present invention can be used with other packet entities such as related packets not all of which contain information identifying the required PDP context.

Preferred embodiments of the present invention have been described in relation to PDP addresses. It should be appreciated that embodiments of the present invention can be used with any other types of address.

It should be appreciated that whilst embodiments of the present invention have been described in relation to the interactive class of the third generation GPRS and/or UMTS, the embodiments of the present invention are applicable to any other classes of any other appropriate standard. The logical connection may also sometimes be referred to as logical associations or bit pipes.

It is also noted herein that while the above describes exemplifying embodiments of the invention, there are several variations and modifications which may be made to the disclosed solution without departing from the scope of the present invention as defined in the appended claims.

The GGSN classifies downlink IP packets with the PDP address and TFTs (if existing). The UE may have at most one PDP context without a TFT, whereas other PDP contexts with the same PDP address must have TFTs. The TFT includes information available in IP and transport layer headers, e.g. source address(es), source port(s) and destination port(s).

If downlink IP packets arc fragmented, e.g. the transport header will not be available in all resulting fragments. If the GGSN should then classify IP packets based on transport header information (i.e. if any of the PDP contexts with the PDP address includes TFT with transport header information), the GGSN may send fragments not including the transport header on a wrong PDP context.

As an example, if the UE has a PDP context without a TFT, a PDP context with the source port 1234 in the TFT and a PDP context with the source port 5678 in the TFT, the GGSN sends fragments without the transport header on the first PDP context, whereas the fragment including the transport header is sent on the second or on the third PDP context according to the source port of the transport header.

In the example above, if the UE does not have a PDP context without a TFT (i.e. the first PDP context), it will not receive fragments without the transport header at all.

This contribution proposes to solve the above problems of packet classification for fragmented IP packets by the GGSN.

The fragments include information on the fragmentation. In case of IPv6, a Fragment I leader is added to the IP packets resulting from fragmentation. The Fragment Header includes e.g. Identification information which is the same in all the fragments (which also have the same source address and destination address). In case of IPv4, this information is included in the IPv4 header.

Most probably, the GGSN received the fragment including the information required for packet classification first. In IP networks, it is, however, possible that the GGSN receives other fragments first, and the fragment including the required information arrives later. If TFTs include information which is not available in all the fragments, the GGSN should wait until it receives the fragment with the required information. Only when receiving this fragment, the GGSN can know on which PDP context all the fragments with the same destination address, source address and identification information should be sent towards the UF.

The solution above requires that the GGSN stores information on the fragmentation together with PDP context information. This contribution proposes that the GGSN stores the source address and identification information and uses the stored information to classify fragments to the right PDP context. It should be noted that the destination address is checked by the GGSN as the PDP address. If the fragment including the required information does not arrive first, the GGSN may have to buffer fragments until receiving the fragment including this information.

In abnormal cases, e.g. when the GGSN buffers overflow, the GGSN may have to either send the old fragments on the most suitable PDP context (i.e. on the PDP context not including TFT if existing) or drop old fragments to release buffer space for newer fragments.

1. A method for directing a packet entity, said method comprising the steps of:
receiving a packet entity;
checking if the packet entity contains information relating to the direction of said entity;
directing said packet entity in accordance with said information if said information is contained in said packet entity: and
storing at least part of said packet entity until a further packet entity is received containing information relating to the direction is received and forwarding said stored packet entity when said further packet entity is received in accordance with said information.

2. A method as claimed in claim 1, wherein said method is arranged to direct a packet entity to a required bearer of a plurality of bearers.

3. A method as claimed in claim 1, wherein said packet entity is a fragmented packet.

4. A method as claimed in claim 3, comprising the step of determining if the packet is a fragmented packet.

5. A method as claimed in claim 2, wherein said checking step comprises checking if said packet entity contains information relating to the required bearer.

6. A method as claimed in claim 4, comprising the step of storing fragmentation related information contained in said packet entity.

7. A method as claimed in claim 1, comprising the step of receiving another packet entity after a packet entity containing said direction information has been received and directing said another packet entity in accordance with the direction information.

8. A method for directing a plurality of related packet entities to a required address, only one or some of said packet entities containing address related information, said method comprising the steps of;
receiving said plurality of packet entities;
determining said required address from at least one of said packet entities containing said address information; and
directing said plurality of related packet entities to said required address.

9. A method as claimed in claim 8, comprising the step of storing at least one packet entity before directing said packet entity to the required address.

10. A method as claimed in claim 9, wherein said at least one packet entity is stored until said required address has been determined.

11. A method as claimed in claim 9, wherein when at least one packet entity has been stored for a predetermined time and said required address has not been determined, an address to which said at least one packet entity is to be sent is selected and said at least one packet is sent to said selected address.

12. A method as claimed in claim 9, wherein when at least one packet entity has been stored for a predetermined time and said required address has not been determined, said at least one packet is removed from a store.

13. A method as claimed in claim 9, wherein if a store storing said at least one packet entity has more than a predetermined amount of data stored therein, an address to which said at least one packet entity is to be sent is selected and said at least one packet is sent to said selected address.

14. A method as claimed in claim 9, wherein if a store storing said at least one packet entity has more than a predetermined amount of data stored therein said at least one packet is removed from said store.

15. A method as claimed in claim 9, wherein information from a header of at least one packet entity is stored.

16. A method as claimed in claim 15, wherein said stored information comprises at least one of the following:
source address, and identification information.

19. A method as claimed in claim 8, wherein said required address comprises a PDP context and/or one of a plurality of bearers and/or a bearer.

20. A method as claimed in claim 8, wherein said address information comprises said destination address.

21. A method as claimed in claim 8, wherein said packet entities comprise one of packets and packet fragments.

22. Apparatus for directing a plurality of related packet entities to a required address, only one or some of said packet entities containing said address information, said apparatus comprising:
means for receiving said plurality of packet entities;
means for determining said required address from at least one of said packet entities containing said address information; and
means for directing said plurality of related packet entities to said required address.

23. Apparatus as claimed in claim 22, wherein said apparatus is usable as a node in a packet switched network.

24. Apparatus as claimed in claim 23, wherein said network is a GPRS network.

25. Apparatus as claimed in claim 22, wherein said apparatus is a GGSN.

26. A method for directing a packet to a required bearer of a set of bearers, the method comprising the steps of:
(a) receiving the packet;
(b) checking if the packet is a fragmented packet and if it is,
(c) checking it the packet comprises information related to selection of the correct bearer and if it does,
forwarding the packet to the correct bearer
storing fragmentation related information contained in the packet
receiving second packet
forwarding said second packet to the correct bearer based on the fragmentation related information,
and if it does not,
storing fragmentation related information contained in the packet storing said packet;
receiving another packet containing information related to the selection of the correct bearer
forwarding another packet and the stored packet(s) to the correct bearer.
